(19) United States
(12) Patent Application Publication
(10) Pub. No.: US 2012/0052169 A1
(43) Pub. Date: Mar. 1, 2012

(54) SERIAL COOKING METHOD AND SYSTEM

(75) Inventors: Malina Elizabeth Janakat, Plano, TX (US); Daniel Eugene ORR, Dallas, TX (US)

(73) Assignee: FRITO-LAY NORTH AMERICA, INC., Plano, TX (US)

(21) Appl. No.: 12/872,041

(22) Filed: Aug. 31, 2010

(51) Int. Cl. A23L 1/01; A47J 37/12; A23L 1/217

(52) U.S. Cl. 426/242; 426/441; 426/637; 99/339

(57) ABSTRACT

A method and system for producing fried food slices with reduced oil content is disclosed. The raw food slices are optionally washed, precooked, fried in hot oil, and then drained at a reduced pressure.

### BACKGROUND OF THE INVENTION

1. Technical Field

The present invention relates to an improved method and system for the production of a fried snack food with a reduced oil content.

2. Description of Related Art

Commercial production of potato chips typically involves a continuous process wherein sliced potatoes are continuously introduced into a vat of frying oil at a temperature of about 300° F. to 365° F. (about 150° C. to 185° C.) or higher, conveyed through the oil by paddles or other means, and removed from the oil after about 2.5 to 3.5 minutes of flying by an endless conveyor belt when the moisture content of the chips has been reduced to about 1% to 3% by weight or less. The resulting product generally has desirable texture and flavor characteristics which are recognizable as typical of potato chips produced commercially by such a continuous process.

Potato chips can also be produced using a batch frying process, which is sometimes referred to as a kettle frying process. These potato chips exhibit somewhat different textural and flavor characteristics, principally due to the oil temperature profile during the frying process.

Regardless of which frying process is used, the potato slices absorb oil, contributing substantially the entire fat content of the resulting potato chips. It would be an improvement in the art to provide a frying method and system which reduces the amount of oil absorbed by the potato chips, while retaining the desirable texture and flavor characteristics imparted by the traditional frying process.

### SUMMARY OF THE INVENTION

The proposed invention provides a method and system for producing fried food slices. In one embodiment, raw food slices are partially precooked, fried by immersion in hot oil at a first pressure, and then removed from the hot oil and drained under a second pressure, which is lower than the first pressure. In a preferred embodiment, the precooker is an infrared oven or an air impingement oven. In another preferred embodiment, the food slices are fried at about atmospheric pressure (about 95 kPa) and drained under vacuum conditions (in one embodiment, about 5 kPa to 50 kPa).

The food slices are optionally washed before precooking in one embodiment. Washing potato slices prior to precooking has been found to reduce the oil content in fried potato chips produced with the present invention by about 4% (about 0.5 grams of oil per one ounce serving of finished product) compared to unwashed potato slices.

The fried food slices produced according to the present invention contain less oil than conventionally fried food slices, yet retain the desirable visual, taste, and textural qualities of the higher oil fried food slices.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart representation of one embodiment of the method of the present invention.

### DETAILED DESCRIPTION

The present invention is directed to a method and system for producing fried food products with reduced oil content. In general, when food products are fried in hot oil, moisture leaves the food product as steam, and the food product absorbs some of the oil in which it is fried. The embodiments described below are directed towards fried potato slices, but the invention in its broadest application applies to any food product that absorbs oil in the process of being fried. The invention is designed to erect and maintain barriers to entry of oil into the food product in order to reduce, but not eliminate, the overall oil content of the finished food product.

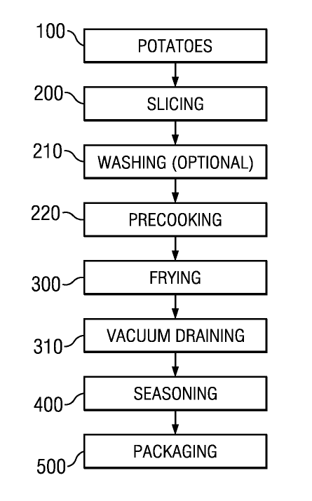

FIG. 1 depicts the general processing steps of one embodiment of the present invention. In preparation for cooking, raw potatoes 100 are washed and optionally brushed to remove the peel. The peeled or unpeeled potatoes 100 are sliced 200 to any suitable thickness (in one embodiment between 0.059 inches to about 0.073 inches) using, for example, variable thickness slicer available from Urschel of Valparaiso, Ind.

The raw slices can be optionally washed 210 or rinsed following the slicing step. Although the inventors herein have surprisingly found that washing the raw potato slices improves the oil reduction performance of the later steps of the present invention, the washing step is not critical to the method or system in its broadest conception. Before testing the present invention, it was theorized that slices which have not undergone a washing step would resist the absorption of oil more than washed potato slices because the starch remaining on the outer surfaces of an unwashed slice would form a crust on such outer surfaces. It was further theorized that the crust would resist the uptake of oil during the frying process. Through subsequent experimental work it was surprisingly determined that washing the potato slices improved oil reduction of the inventive process by at least 4% over unwashed potato slices, when all other processing parameters are unchanged.

Next, the washed or unwashed slices are transferred to a pre-cooker 220 before frying 300. In a preferred embodiment, the pre-cooker is an air impingement oven or an infrared (IR) oven. Without being limited by theory, it is theorized that the pre-cooker forms a crust on the outer surfaces of the potato slice, and reduces the size of any pores present on the surface of the slice, which resists the absorption of oil into the slice during later frying operations by reducing the size of any pores present on the surface of the slice. Regardless of theory, it has been experimentally determined that combining the air impingement or IR precooking step with the later frying steps described below results in substantial reduction in the amount of oil present in the fully cooked potato slice.

In a preferred embodiment, the potato slices are mono-layered before being transferred into the IR or impingement precooker. If the slices are not mono-layered, the precooking step is less efficient in creating the desired crust and pore size reduction because the impingement and/or IR oven work best when the entire potato slice surface is exposed. Also, the residence time of the potato slices inside the precooker, and the temperature of the precooker, are important variables in producing potato chips that closely resemble prior art fried potato chips. Testing has indicated that as oven temperature and time increase, the texture and flavor of the potato chips becomes less desirable. Experimental data indicate that high moisture reductions cause the potato slices to become brown and oily during subsequent frying. In one embodiment, the temperature of the air in the air impingement precooker is between 250° C. and 350° C. In another embodiment, the temperature inside the IR oven precooker is between about 300° C. and about 450° C. The residence time of the slices in the precooker ranges from about 1 to about 4 minutes.

After exiting the precooker, the potato slices are then fried 300 in hot oil. The frying can take place in a batch “kettle” process, a continuous fryer, or a combination of the two. The frying may also take place at ambient or atmospheric pressure, or under vacuum pressures. In a preferred embodiment, the frying occurs under ambient or atmospheric pressure (approximately 95 kPa). The frying time for the potato slices can vary, in one embodiment from 60 seconds to 180 seconds, depending on slice thickness and pre-cooking times and temperatures. In one embodiment, the potato slices are fried to a final moisture content below about 2.5% by weight.

When the potato slices are removed from the hot oil, the slices are immediately drained 310 and cooled at a pressure below the frying pressure, and preferably at vacuum pressures (or, pressures below atmospheric pressure). Without being limited by theory, it is believed that a significant portion of oil uptake into the slice occurs during the draining/cooling phase of the potato slice frying process. Upon exiting the fryer, any water occupying the pores inside the potato slices is present in the vapor phase because the temperature of the water in the slice has been raised above its boiling point. It is theorized that the vapor pressure of this remaining water resists the uptake of oil as the oil is draining from the potato slice. However, as the slice cools, the vapor pressure of the water is reduced until it reaches a temperature where the vapor condenses into liquid water. The reduced volume of the liquid water as compared with water present in the vapor phase leaves voids available for oil to absorb into pores on the surface of the slice through capillary or other action. By reducing the pressure surrounding the potato slices during the draining/cooling step, the water vapor inside the chip can remain in the vapor state for a longer period of time than it does under previous processes. The water present inside the chips has an increased vapor pressure under vacuum conditions, and remains in the vapor state for a longer period of time because the chips cool more slowly in the lower density surrounding medium created by the vacuum conditions. This effectively increases the draining time for the oil before the water vapor condenses and allows oil to penetrate into the potato slice. The result of the process of the present invention is a potato chip with substantially reduced oil content in comparison to a potato chip made using previous frying processes, but which retains the desirable flavor, texture and mouthfeel characteristics associated with potato slices fried according to the prior art.

It was also experimentally determined that a larger difference between the frying pressure and the draining pressure results in a bigger reduction in oil uptake during draining. In one embodiment, frying occurs at atmospheric pressures (about 95 kPa), and draining occurs at pressures between about 5 kPa to 50 kPa. Thus, using a reduction in pressure between frying and draining of at least 50% provides surprisingly improved results over control.

In another embodiment, the fried potato slices are allowed to drain under vacuum conditions, and under modest heat, allowing the water to remain a vapor for an even longer period of time than when no heat is applied during the draining step.

Combining the pre-cooking and vacuum draining/cooling steps synergistically reduces the amount of oil uptake into the potato slice during the frying process. The optimum conditions for the inventive process include low pressures during the draining step, low temperature and short residence time for the precooking step, atmospheric frying temperatures and washing the slices. In particular, the draining/cooling step should occur at a pressure below the pressure used during the frying step.

The potato chips can then be sent to be seasoned 400 and packaged 500 as known in the art.

### EXAMPLES

Control samples of potato chips were made by washing, peeling and slicing potatoes as is known in the art. The potato slices were then washed to remove surface starch. The control slices were fried at atmospheric pressure (about 95 kPa) at an oil temperature of about 345° F. to a final moisture content below about 2.5% by weight, and drained at atmospheric pressure (about 95 kPa) for about 3 minutes. The resulting control potato chips had an average oil content of about 11 grams of oil per ounce of potato chips.

A series of potato slice samples were optionally precooked (to a moisture content between about 60% and about 75%), fried to a moisture content below about 2.5% by weight, and drained under various processing conditions for about 3 minutes to compare to control. Potato slices that were not precooked, fried at atmospheric pressure, and drained under vacuum (about 5 kPa), had an average oil content of about 8.22 grams of oil per ounce of potato chips. Potato slices that were precooked by air impingement, and fried and drained at atmospheric pressure (about 95 kPa), had an average oil content of about 9.06 grams of oil per ounce of potato chips. Potato slices that were precooked by air impingement, fried at atmospheric pressure, and drained under vacuum (about 5 kPa) had an average oil content of about 7 grams of oil per ounce of potato chips. Potato slices that were precooked in an infrared oven, fried at atmospheric pressure, and drained under vacuum had an average oil content of about 5.87 grams of oil per ounce of potato chips. These results showed a high degree of repeatability, and consistently produced potato slices far lower in oil content than control, yet still having the desirable taste and textural characteristics of conventionally fried potato slices.

It will now be evident to those skilled in the art that there has been described herein a method and system that can be used to produce fried food slices that have reduced oil content but retain the desirable characteristics of conventionally fried food slices. Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

In sum, while this invention has been particularly shown and described with reference to a preferred embodiment, it will be understood by those skilled in the art that various changes, in form and detail may be made therein without departing from the spirit and scope of the invention.

What is claimed is:

1. A method for making a fried food chip comprising the steps of:
providing a plurality of raw food slices;
precooking said raw food slices to produce precooked food slices;
frying said precooked food slices by immersion in hot oil at a first pressure to produce fried food slices; and
draining said fried food slices at a second pressure, wherein said second pressure is lower than said first pressure.

2. The method of claim 1 further comprising washing said raw food slices prior to said precooking step.

3. The method of claim 1 wherein said precooking comprises precooking said raw food slices in an infrared oven.

4. The method of claim 1 wherein said precooking comprises precooking said raw food slices in an air impingement oven.

5. The method of claim 1 wherein said first pressure is about atmospheric pressure.

6. The method of claim 5 wherein said second pressure is between about 5 kPa and about 50 kPa.

7. The method of claim 1 wherein said second pressure is at least 50% lower than said first pressure.

8. The method of claim 1 wherein precooking further comprises producing precooked food slices at a moisture content between about 60% and about 75% by weight.

9. A fried food chip made according to the method of claim 1.

10. A system for producing fried food slices comprising:
a precooker adapted to receive raw food slices and produce precooked food slices;
a fryer adapted to fry said precooked food slices in hot oil at a first pressure to produce fried food slices; and
a drainer adapted to receive said fried food slices and drain said fried food slices under a second pressure, wherein said second pressure is lower than said first pressure.

11. The system of claim 10 further comprising a washer adapted to wash said raw food slices prior to being sent to said precooker.

12. The system of claim 10 wherein said precooker comprises an infrared oven.

13. The system of claim 10 wherein said precooker comprises an air impingement oven.

14. The system of claim 10 wherein said first pressure is about atmospheric pressure.

15. The system of claim 10 wherein said second pressure is between about 5 kPa and about 50 kPa.

16. The system of claim 10 wherein said second pressure is about 50% lower than said first pressure.

17. The system of claim 10 wherein said precooker produces said precooked food slices at a moisture content between about 60% and about 75%.
